(19) United States
(12) Patent Application Publication
(10) Pub. No.: US 2005/0200876 A1
(43) Pub. Date: Sep. 15, 2005

(54) Device, method and program for structured document processing

(75) Inventors: Keiichi Iguchi, Tokyo (JP); Kazuya Koyama, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/075,745

(22) Filed: Mar. 10, 2005

(30) Foreign Application Priority Data
Mar. 11, 2004 (JP) 069162/2004

(51) Int. Cl. G06F 15/00

(52) U.S. Cl. 358/1.13

(57) ABSTRACT

A structured document processing device, a structured document processing method and a structured document processing program, for, when processor modules dynamically selected for use in processing document data require different data formats, minimizing syntax analysis and data format conversion as well as improving process efficiency. In structured document data processing, when document data is input, processor modules for use in processing the data are determined. The result of the determination is output to a module controller. Having received the determination result, the module controller checks whether or not the data format of the document data to be processed matches the data format required by a processor module that is to perform processing next. When the two data formats do not match, the document data is converted to the data format required by the processor module. After that, the module controller passes the document data to the processor module. The module controller then calls the processor module and stores the processing result in a storage. This process is sequentially repeated with respect to all processor modules. On completion of the processing, the document data is output.

### FIELD OF THE INVENTION

The present invention relates to a structured document processing device for processing structured document data used in a plurality of data formats with processor modules, more particularly, to a structured document processing device, a structured document processing method and a structured document processing program for processing structured document data by switching a plurality of processor modules dynamically.

### BACKGROUND OF THE INVENTION

Communication repeaters have been used for relaying structured document data exchanged between a plurality of computers.

The conventional communication repeater may be provided with a plurality of modules corresponding to processing. According to the content of communication, the type of processing, such as encryption, signature verification and data logging, is determined, and one or more modules are called for use in performing the processing. There are found such communication repeaters in the following References:
1. Published Japanese translations of PCT international publication for patent application No. 2002-518726
2. Yutaka Sato, “Basic Technology and Application of Internet Firewalls—Mechanism of DeleGate”, Computer Software, Iwanami Shoten, Publishers, Vol. 14, No. 1, pp. 55-63, January, 1997
3. Satoshi Kumada, “Guide to Practical Use of Servlet Filter”, monthly “JavaWorld”, Vol. 6, No. 11, pp. 67-77, Nov. 1, 2002
4. “Internet Content Adaptation Protocol (ICAP)”, online, searched on Mar. 1, 2004, on the Internet at URL: http://www.i-cap.org/docs/icap_whitepaper_v1-01.pdf

Incidentally, according to techniques described in References 1 to 4, a document processing system for performing various processes for document data is applied to a communication repeater.

More specifically, Reference 1 discloses that filtering is carried out by a communication repeater, and that filter rules are defined in modules and a new rule is handled by adding a module.

In Reference 2, API (Application Programming Interface) for calling external modules is defined in a communication repeater, and the external modules are sequentially called at execution time. Besides, the modules are used for a program to receive relayed messages, and have functions for changing messages or the like.

In Reference 3, chain reaction calls are made to modules in a server, and various processes are added before or after access to actual resources.

In Reference 4, contents are sequentially transmitted from a proxy server to a content conversion server, and thereby conversion processing or the like is performed. Additionally, modules may be placed at a remote location connected through a communication network.

FIG. 1 is a block diagram showing an example of a conventional document processing system.

Referring to FIG. 1, a document processing system 800 comprises an input/output section 810 for inputting/outputting document data, a module selection section 820 for selecting modules to be used, a document storage 830 for storing document data, a module controller 850, and a processor module management section 860 for managing processor modules 870.

In the following, a description will be given of the operation of the document processing system 800.

When document data is input, first, the module selection section 820 selects processor modules for use in processing the data based on predetermined conditions and the data received.

Next, the module controller 850 fetches the processor modules selected by the module selection section 820 from the processor module management section 860. Then, the module controller 850 sequentially passes the document data in the same format to the processor modules and calls the modules.

In the above-described conventional technique, processor modules for use are dynamically determined. However, the module controller 850 controls only processor modules that require a uniform data format predetermined at design time to process document data.

Consequently, all processor modules receive document data in the same format regardless of whether or not the information is necessary within the respective modules.

That is, in this construction, the module controller 850 performs no syntax analysis and each processor module conducts the analysis if required, or the module controller 850 performs some kind of syntax analysis regardless of whether or not each processor module needs it to pass the analyzed information to the module.

As is described above, in the conventional document processing system, processor modules for use are dynamically determined. However, all processor modules are fed with document data in a uniform data format determined in advance with disregard to the case where the syntax analysis/data format conversion load is heavy.

When structured document data is processed in a system where a plurality of processor modules are used for processing document data, it is necessary to perform syntax analysis and data format conversion for the data depending on the contents of the data to be processed or the types of processor modules. However, according to the conventional technique, all processor modules are fed with document data in a uniform data format, and therefore, process efficiency may be decreased.

More specifically, in a system using the API by which document data is passed to processor modules without syntax analysis, each processor module conducts the analysis if required. Consequently, if a plurality of processor modules need to conduct syntax analysis, the same analytical processing is performed redundantly by the modules, which decreases process efficiency.

On the other hand, in a system using the API by which document data which has undergone syntax analysis or an analysis result is passed to processor modules, only one analytical processing is performed even when a plurality of processor modules for use need the analysis. However, when no processor module that needs syntax analysis is to be used, unnecessary analysis is performed, which also decreases process efficiency.

In addition, when document data to be processed is in XML (eXtended Markup Language) format, etc. with a heavy syntax analysis load, such unnecessary analytical processing can be the main cause of deterioration in the execution performance of the system.

### SUMMARY OF THE INVENTION

It is therefore an object of the present invention to provide a structured document processing device, a structured document processing method and a structured document processing program, applied to a system in which processor modules are dynamically selected for use in processing document data, capable of minimizing syntax analysis and data format conversion as well as improving process efficiency in the case that the respective processor modules require different data formats.

In accordance with an aspect of the present invention, to achieve the object mentioned above, there is provided a structured document processing device processing structured document data used in a plurality of data formats with one or more processor modules, which selects one or more processor modules for use in processing received structured document data from among a plurality of processor modules each processing data in a specified format, and, when instructing the processor module selected for use to perform processing, determines whether or not the data format acceptable to the processor module matches that of the structured document data to be processed by the processor module to convert the structured document data to the data format acceptable to the processor module if the data formats have been determined to be mismatched, thereby processing the structured document data with the processor module(s) and outputting the processing result.

By virtue of this construction, in a system where processor modules are dynamically selected for use in processing structured document data, when the respective modules require different data formats, syntax analysis and data format conversion can be minimized. Thus, it is possible to improve process efficiency.

In accordance with another aspect of the present invention, there is provided a structured document processing device processing structured document data used in a plurality of data formats with one or more processor modules, comprising: a receiver for receiving structured document data; a processor module selector for selecting one or more processor modules for use in processing the structured document data received by the receiver from among a plurality of processor modules each processing data in a specified format; a module controller for instructing the processor module selected for use by the processor module selector to perform processing; a data format converter for converting the data format of the structured document data; and a transmitter for transmitting the processing result obtained by the processor module(s) selected by the processor module selector; wherein the module controller includes a determination means for, when the module controller instructs the processor module selected for use to perform processing, determining whether or not the data format acceptable to the processor module matches that of the structured document data to be processed by the processor module, and the data format converter converts the structured document data to the data format acceptable to the processor module if the determination means has determined that the data formats do not match.

By virtue of this construction, in a system where processor modules are dynamically selected for use in processing structured document data, when the respective modules require different data formats, syntax analysis and data format conversion can be minimized. Thus, it is possible to improve process efficiency.

The structured document processing device may further comprise a document data storage for storing structured document data received by the receiver. In this case, the module controller may store the processing result obtained by the processor module(s) selected for use by the processor module selector in the document data storage so that the transmitter can transmit the processing result stored in the document data storage.

The data format converter may be implemented by one or more data format conversion modules for converting the data format of structured document data.

The module controller may also instruct the data format conversion module to perform processing, and determine the execution sequence of the processor modules selected by the processor module selector and the data format conversion modules necessary for the data format conversion. In this case, the module controller may provide each module with information on instructions for the execution of a module subsequent to the module, and instruct the first module in the execution sequence to perform processing.

By virtue of this construction, the module controller is not required to be in control of processing by all modules after calling the first module until the modules complete their processing. Thus, the module controller can perform another process in the meantime, which improves process efficiency.

The module controller may select one execution sequence of the processor modules and the data format conversion modules from a number of possible execution sequences so that, for example, the entire load of processing performed by the processor modules and the data format conversion modules is minimized.

The module controller may determine the execution sequence of the processor modules and the data format conversion modules within predetermined constraints on the execution sequence of the processor modules.

The processor modules may be installed in an external device outside the structured document processing device. In this case, the module controller may instruct the processor module installed in the external device to perform processing via a communication network, such as the Internet, a public line, a private line and a radio communication line.

The data format conversion modules may include one or more of those installed in an external device outside the structured document processing device. In this case, the module controller may instruct the data format conversion module installed in the external device to perform processing via a communication network, such as the Internet, a public line, a private line and a radio communication line.

The receiver may receive structured document data via a communication network, and the transmitter may transmit the processing result obtained by the processor module(s) via a communication network.

The receiver may receive request document data as structured document data, and response document data returned in response to the result of processing the request document data obtained by the processor module(s). Besides, the transmitter may transmit the result of processing the request document data obtained by the processor module(s), and the result of processing the response document data obtained by the processor module(s).

The processor module selector may determine to use one or more processor modules used for processing the request document data for processing the response document data.

The module controller may retain one or more processor modules used for processing the request document data so as to use the processor modules for processing the response document data. In this case, the processor module selector need not select one or more processor modules to be used for processing the response document data.

Preferably, the structured document data is XML document data.

In accordance with another aspect of the present invention, there is provided a structured document processing method for processing structured document data used in a plurality of data formats with one or more processor modules, comprising the steps of receiving structured document data; selecting one or more processor modules for use in processing the received structured document data from among a plurality of processor modules each processing data in a specified format; instructing the processor module selected for use to perform processing; determining, when instructing the processor module selected for use to perform processing, whether or not the data format acceptable to the processor module matches that of the structured document data to be processed by the processor module; and converting the structured document data to the data format acceptable to the processor module if the data formats have been determined to be mismatched.

By virtue of this construction, in a system where processor modules are dynamically selected for use in processing structured document data, when the respective modules require different data formats, syntax analysis and data format conversion can be minimized. Thus, it is possible to improve process efficiency.

The conversion of data format is implemented by one or more data format conversion modules for converting the data format of structured document data.

The structured document processing method may further comprises the steps of determining the execution sequence of the processor modules selected for use and the data format conversion modules necessary for the data format conversion; providing each module with information on instructions for the execution of a module subsequent to the module; and instructing the first module in the execution sequence to perform processing.

One execution sequence of the processor modules and the data format conversion modules may be selected from a number of possible execution sequences so that the entire load of processing performed by the processor modules and the data format conversion modules is minimized.

The execution sequence of the processor modules and the data format conversion modules may be determined within predetermined constraints on the execution sequence of the processor modules.

In accordance with another aspect of the present invention, there is provided a structured document processing program for processing structured document data used in a plurality of data formats with one or more processor modules, making a computer perform the steps of receiving structured document data; selecting one or more processor modules for use in processing the received structured document data from among a plurality of processor modules each processing data in a specified format; instructing the processor module selected for use to perform processing; determining, when instructing the processor module selected for use to perform processing, whether or not the data format acceptable to the processor module matches that of the structured document data to be processed by the processor module; and converting the structured document data to the data format acceptable to the processor module if the data formats have been determined to be mismatched.

By virtue of this construction, in a system where processor modules are dynamically selected for use in processing structured document data, when the respective modules require different data formats, syntax analysis and data format conversion can be minimized. Thus, it is possible to improve process efficiency.

Under the control of the program, the computer may implement the conversion of data format using one or more data format conversion modules for converting the data format of structured document data.

Under the control of the program, the computer may perform the further steps of determining the execution sequence of the processor modules selected for use and the data format conversion modules necessary for the data format conversion; providing each module with information on instructions for the execution of a module subsequent to the module; and instructing the first module in the execution sequence to perform processing.

Under the control of the program, the computer may perform the step of selecting one execution sequence of the processor modules and the data format conversion modules from a number of possible execution sequences so that the entire load of processing performed by the processor modules and the data format conversion modules is minimized.

Under the control of the program, the computer may perform the step of determining the execution sequence of the processor modules and the data format conversion modules within predetermined constraints on the execution sequence of the processor modules.

As described above, in accordance with the present invention, when the data format of structured document data to be processed by a processor module differs from that required by the processor module, the structured document data is converted to the data format acceptable to the processor module. Consequently, in a system where processor modules are dynamically selected for use in processing structured document data, when the respective modules require different data formats, syntax analysis and data format conversion can be minimized. Thus, it is possible to improve process efficiency.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing an example of a conventional document processing system;

FIG. 2 is a block diagram showing an example of the construction of a structured document processing system according to the first embodiment of the present invention;

FIG. 3 is a flowchart showing an example of structured document data processing according to the first embodiment of the present invention;

FIG. 4 is a flowchart showing an example of structured document data processing according to the second embodiment of the present invention;

FIG. 5 is a block diagram showing an example of the construction of a structured document processing system according to the fourth embodiment of the present invention;

FIG. 6 is a flowchart showing an example of structured document data processing according to the fifth embodiment of the present invention;

FIG. 7(A) is a diagram showing an example of an execution sequence list;

FIG. 7(B) is a diagram showing another example of an execution sequence list;

FIG. 8 is a block diagram showing an example of the construction of a structured document processing device according to the sixth embodiment of the present invention;

FIG. 9 is a flowchart showing an example of structured document data processing according to the sixth embodiment of the present invention;

FIG. 10 is a flowchart showing an example of structured document data processing according to the seventh embodiment of the present invention;

FIG. 11 is a block diagram showing an example of a construction including a structured document processing program for implementing structured document data processing;

FIG. 12 is a block diagram showing the construction of a structured document processing device according to the first practical example of the present invention; and

FIG. 13 is a block diagram showing the construction of a structured document processing device according to the third practical example of the present invention.

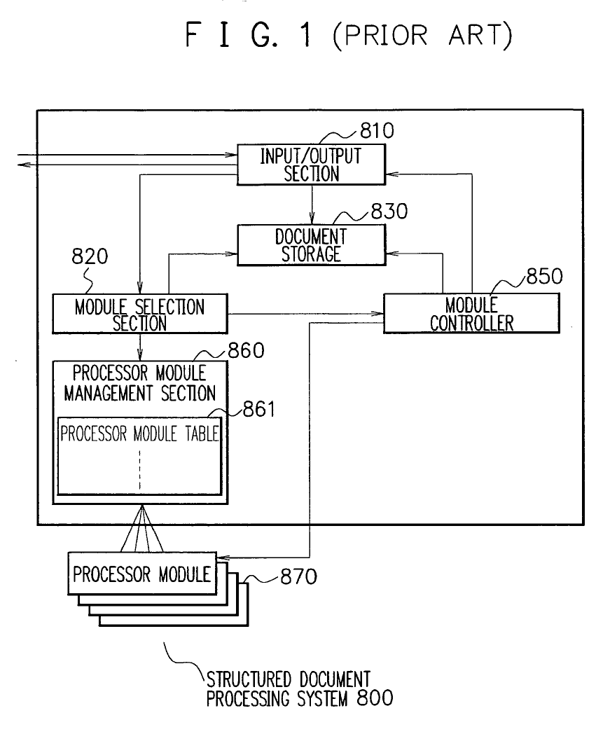

### DESCRIPTION OF THE PREFERRED EMBODIMENTS

Referring now to the drawings, a description of preferred embodiments of the present invention will be given in detail.

Hereinafter, the first embodiment of the present invention will be described.

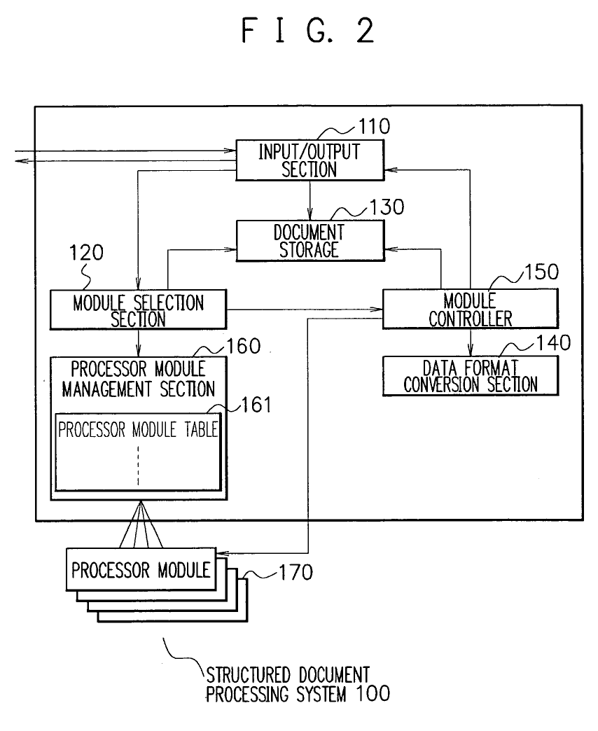

FIG. 2 is a block diagram showing an example of the construction of a structured document processing system according to the first embodiment of the present invention.

Referring to FIG. 2, a structured document processing system 100 comprises an input/output section 110, a module selection section 120, a document storage 130, a data format conversion section 140, a module controller 150, and a processor module management section 160.

The input/output section 110 has functions of inputting document data to be processed and outputting the result of processing. More specifically, the input/output section 110 receives document data to be processed and stores the data in the document storage 130 as well as outputting the result of processing stored in the document storage 130 after the processing.

The module selection section 120 has a function of determining processor modules for use in processing document data to be processed. More specifically, the module selection section 120 determines processor modules for use in processing document data stored in the document storage 130, and outputs the result of the determination to the module controller 150.

The document storage 130 is composed of a storage medium such as a RAM (Random Access Memory). The document storage 130 stores document data to be processed and a variety of information including processing results.

The data format conversion section 140 converts the data format of document data to another data format in response to a request from the module controller 150.

For example, in the case of XML (eXtensible Markup Language) data, examples of data formats include SAX (Simple API for XML) format, DOM (Document Object Model) format, character string format or the like.

The module controller 150 performs a variety of control functions as for example to call a processor module. Concretely, the module controller 150 controls the data format conversion section 140 to convert sequentially document data to be processed, which are stored in the document storage 130, to a data format required by each processor module.

In addition, the module controller 150 controls a relevant processor module to process document data, whose data format has been converted by the data format conversion section 140. The processing result obtained by the processor module is stored in the document storage 130 under the control of the module controller 150.

The processor module management section 160 includes a processor module table 161 as a management table for managing a plurality of processor modules set therein.

In the following, a description will be given of the operation of the structured document processing system 100 according to the first embodiment of the present invention.

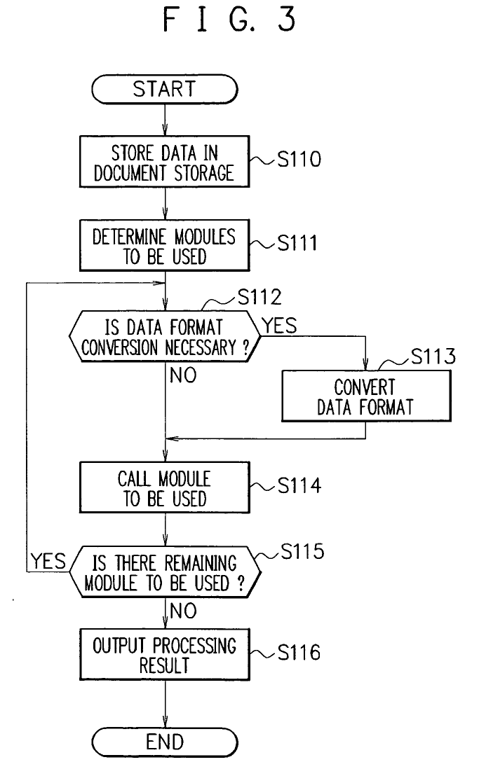

FIG. 3 is a flowchart showing an example of structured document data processing performed by the structured document processing system 100.

In the structured document data processing, when document data is input, first, the input/output section 110 stores the input data to be processed in the document storage 130 (step S110).

After the document data to be processed are stored in the document storage 130, the module selection section 120 selects processor modules for use in processing the data stored in the document storage 130 from among processor modules 170 in the processor module table 161 managed by the processor module management section 160 (step S111).

Incidentally, in step S111, the module selection section 120 determines a processor module for use in processing document data according to prescribed conditions. For example, in the case where each processor module used for processing document data is specified in advance based on the sender of the data, the module selection section 120 checks the sender of document data stored in the document storage 130 to select one or more processor modules for use in processing the data based on the sender.

Having received the result of the determination as to the processor modules to be used, the module controller 150 checks whether or not the data format of the document data to be processed, which has been stored in the document storage 130 in step S110, matches the data format required by the processor module that is to perform processing next (step S112).

In this embodiment, each of the processor modules 170 in the processor module table 161 is associated with a data format acceptable to the processor module. In other words, “data format required by each processor module” indicates a data format that is associated with the processor module beforehand as an acceptable data format.

When the two data formats do not match, and a data format conversion is required (step S112/Yes), the module controller 150 outputs the document data to be processed to the data format conversion section 140. Accordingly, the data format conversion section 140 converts the data format of the document data to be processed into the data format required by the processor module that is to perform processing next (step S113).

On receipt of the document data whose data format has been converted from the data format conversion section 140, the module controller 150 stores the data in the document storage 130.

On the other hand, when the two data formats match, and a data format conversion is not required (step S112/No), the module controller 150 stores the document data directly in the document storage 130 without converting the format of the data.

After that, the module controller 150 passes the document data stored in the document storage 130 to the processor module that is to perform processing next. The module controller 150 then calls the processor module and stores the processing result in the document storage 130 (step S114). Incidentally, “to call the processor module” indicates “to instruct the processor module to perform processing”.

Besides, when there exists a processor module, for which the module controller 150 has not yet carried out, for example, the matching check in step S112 among those selected for use in step S11, the process returns to step S112 (step S115).

As is described above, steps from S112 through S114 are sequentially repeated with respect to all the processor modules selected in step S111.

On completion of the processing of all the processor modules, the input/output section 110 outputs document data representing the processing result stored in the document storage 130 (step S116). On this occasion, if the document data corresponding to the processing result stored in the document storage 130 are not in a data format for transmission, the data format conversion section 140 converts the data to a data format for transmission before the input/output section 110 outputs it.

Incidentally, in step S116, the input/output section 110 transmits the document data as the processing result to the sender of the data.

As described above, according to the first embodiment, in the case where the module controller 150 instructs a plurality of processor modules each requiring a different data format to perform processing, the data format conversion section 140 converts the data format of document data only when necessary under the control of the controller 150. Consequently, unnecessary data format conversions can be avoided. Thereby, it is possible to reduce the load of the data format conversion process.

In other words, only when the data format of structured document data does not match the data format required by a processor module, the format of the data is converted. Thereby, in a system where processor modules are dynamically selected for use in processing structured document data, when the respective modules require different data formats, syntax analysis and data format conversion can be minimized. Thus, it is possible to improve process efficiency.

That is, according to the first embodiment, the module controller 150 has a function for controlling plural types of processor modules each requiring a different data format. The processor modules are associated with their acceptable data formats, respectively, so that the conversion of data formats can be implemented only when needed. By virtue of this construction, the repetition of the same data format conversion and unnecessary data format conversion can be prevented.

Hereinafter, the second embodiment of the present invention will be described.

A structured document processing system of the second embodiment has essentially the same construction as described previously for the structured document processing system 100 in connection with FIG. 2. Therefore, the construction of the structured document processing system of the second embodiment will be described referring to FIG. 2, and the detailed description will not be repeated here.

In this embodiment, the module controller 150 checks data formats required by respective processor modules before instructing the modules to perform processing. Accordingly, the module controller 150 changes the execution sequence or order of the processor modules so that the load of the data format conversion process can be minimized on the whole.

In the following, a description will be given of the operation of the structured document processing system according to the second embodiment of the present invention.

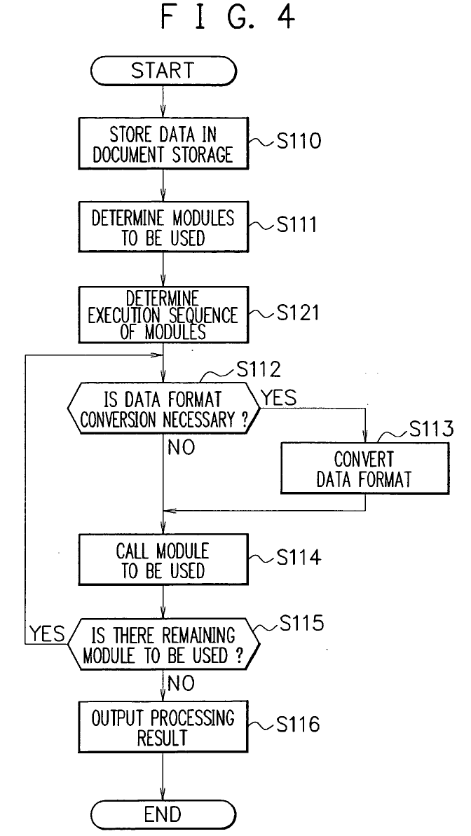

FIG. 4 is a flowchart showing an example of structured document data processing performed by the structured document processing system 100 of the second embodiment.

In the structured document data processing, after steps S110 and S111 described previously in connection with FIG. 3, the module controller 150 checks the data formats required by the processor modules selected in step S111 all at once, and determines the execution sequence of the processor modules so that the load of the data format conversion process can be minimized on the whole (step S121).

For example, it is assumed that the module selection section 120 has selected the processor modules “a” and “c” requesting the data format “A” and the processor module “b” requesting the data format “B” for use in processing the document data in step S111. In such case, if the processor modules “a”, “b” and “c” perform processing in this order, the document data will be converted to the data format “A”, then to the data format “B”, and after that, to the data format “A” again. On the other hand, if the processor modules “a”, “c” and “b” perform processing in this order, the document data will just be converted to the data format “A”, and then to the data format “B” after the modules “a” and “c” complete their processing.

In cases like this, the module controller 150 determines that the processor modules “a”, “c” and “b” will perform processing in this order so that the load of the data format conversion process can be minimized (e.g. so that the number of data format conversions can be minimized) on the whole in step S121.

Incidentally, the module controller 150 may determine the execution sequence of processor modules using, for example, an execution sequence decision table in which the association of each combination of processor modules for use with the execution sequence of the modules is preset. Besides, the module controller 150 may calculate the number of data format conversions with respect to every execution sequence for each combination of processor modules to determine the order of the modules based on the result of the calculation such that the number of data format conversions can be minimized.

Next, the module controller 150 performs the process from step S112 through S114 for all the processor modules selected for use in processing the document data in step S111 in the order determined in step S121.

After that, as in the first embodiment, the input/output section 110 outputs document data as the processing result stored in the document storage 130 (step S116).

As described above, according to the second embodiment, the module controller 150 determines the execution sequence of processor modules for use before instructing the modules to perform processing so that the number of data format conversions can be minimized. Thereby, the load of the data format conversion process can be reduced on the whole. Thus, it is possible to further improve process efficiency.

Hereinafter, the third embodiment of the present invention will be described.

A structured document processing system of the third embodiment has essentially the same construction as described previously for the structured document processing system 100 in connection with FIG. 2. Therefore, the construction of the structured document processing system of the third embodiment will be described referring to FIG. 2, and the detailed description will not be repeated here.

In this embodiment, as in the aforementioned second embodiment, the module controller 150 checks data formats required by respective processor modules before instructing the modules to perform processing. Accordingly, the module controller 150 determines the execution sequence or order of the processor modules to perform processing so that the load of the data format conversion process can be minimized on the whole.

However, in this embodiment, there are constraints or restrictions as to the execution sequence of processor modules. When determining the order of processor modules (step S121 in FIG. 4), the module controller 150 obtains information on the execution sequence constraints, and changes the order within the constraints.

For example, the module controller 150 obtains the information on the execution sequence constraints from each processor module. In this case, the condition that a processor module must perform processing before or after the other specific module(s) may be set in advance as the execution sequence constraints for the relevant modules. Or also, the information on the execution sequence constraints may be established as rules independent of processor modules by, for example, constructing a table in which the execution sequence constraints are set.

As is described above, according to the third embodiment, there are constraints or restrictions as to the execution sequence of processor modules. The module controller 150 changes the order of processor modules while heeding the execution sequence constraints. Thus, it is possible to improve process efficiency as the execution sequence constraints are satisfied.

Hereinafter, the fourth embodiment of the present invention will be described.

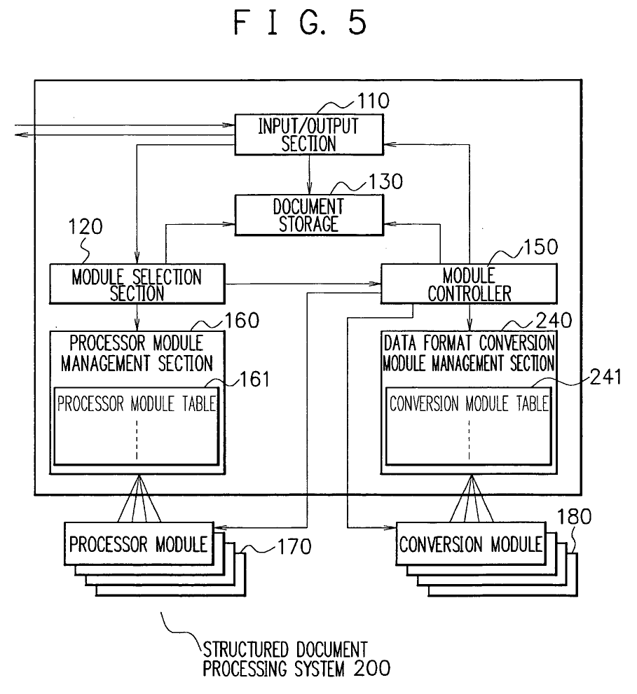

FIG. 5 is a block diagram showing an example of the construction of a structured document processing system according to the fourth embodiment of the present invention. Incidentally, the structured document processing system shown in FIG. 5 is in many respects basically similar to that of FIG. 2, and like numerals are utilized in designating corresponding portions of the system.

As can be seen in FIG. 5, the structured document processing system 200 comprises an input/output section 110, a module selection section 120, a document storage 130, a data format conversion module management section 240, a module controller 150, and a processor module management section 160.

The data format conversion module management section 240 manages a plurality of conversion modules 180 constructed by modularizing the functions of the data format conversion section 140 with respect to each data format conversion function.

The conversion modules 180 are set in a conversion module table 241 managed by the data format conversion module management section 240.

The structured document processing system 200 of the fourth embodiment performs structured document data processing in the same manner as previously described in connection with FIG. 3.

However, in this embodiment, in the process of converting the data format of the document data (step S113), under the control of the module controller 150, the data format conversion module management section 240 selects the conversion module 180 for converting data formats set in the conversion module table 241, and the selected module 180 performs the conversion of data formats differently from the process shown in FIG. 3.

As is described above, according to the fourth embodiment, the conversion modules 180 are constructed by modularizing functions for converting data formats. It is possible to add, delete or change the conversion modules 180 easily. Consequently, even if there is need for a processor module requiring a new data format to perform processing in the structured document processing system 200, a new conversion module that performs conversion to the new data format can be easily added. Thus, processing can be facilitated.

Hereinafter, the fifth embodiment of the present invention will be described.

A structured document processing system of the fifth embodiment has essentially the same construction as described previously for the structured document processing system 100 in connection with FIG. 2. Therefore, the construction of the structured document processing system of the fifth embodiment will be described referring to FIG. 2, and the detailed description will not be repeated here.

In this embodiment, an interface for specifying the processor module that is to perform processing next is set with respect to each processor module, and processing by the respective modules is performed serially or sequentially.

In the following, a description will be given of the operation of the structured document processing system according to the fifth embodiment of the present invention.

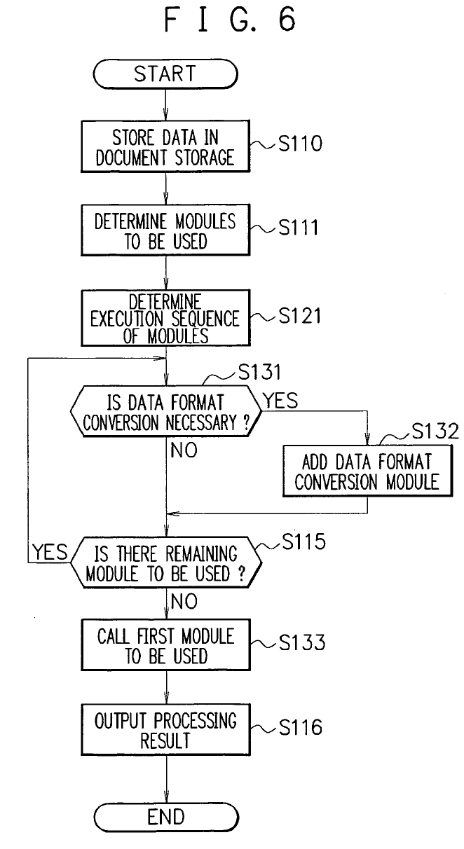

FIG. 6 is a flowchart showing an example of structured document data processing performed by the structured document processing system 100 of the fifth embodiment.

In the structured document data processing, after steps S110 and S111 described previously in connection with FIG. 3, the module controller 150 constructs an execution sequence list of all processor modules to perform processing (step S121).

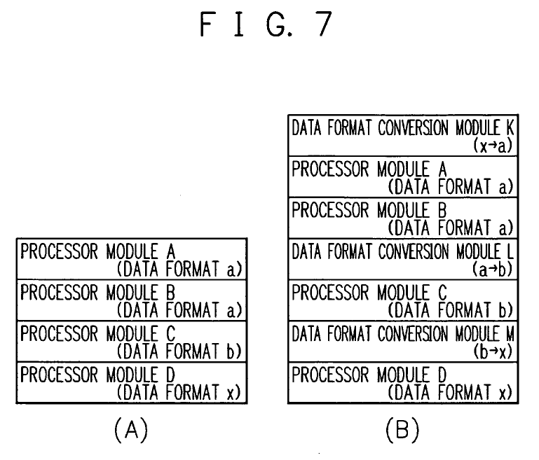

On the execution sequence list constructed in step S121, for example, as shown in FIG. 7(A), processor modules are listed in the order in which the modules will perform processing.

In this embodiment, as shown in FIG. 7(A), it is assumed that the processor module “A” requesting the data format “a”, the processor module “B” requesting the data format “a”, the processor module “C” requesting the data format “b” and the processor module “D” requesting the data format “x” perform processing in the order named. In addition, document data transmitted/received to/from the structured document processing system 100 assumed here is in the data format “x”.

Next, the module controller 150 checks whether or not the data format required by the processor module that is to perform processing next matches the data format of the document data which has been stored in the document storage 130 in step S110 (in the case of the first processing or processing by the first module) or that of the data after the previous processing or processing by the preceding module (from the second processing) (step S131).

When the two data formats do not match, and a data format conversion is required (step S131/Yes), the module controller 150 places a processor module for making the data format conversion section 140 convert the data format into that required by the next processor module, which is to perform processing next, or the conversion module 180 for converting the data format into that required by the next processor module before the next processor module on the execution sequence list (step S132).

When there exists a processor module, for which the module controller 150 has not yet carried out, for example, the matching check in step S131 among those selected for use in step S111, the process returns to step S131 (step S115). That is, the module controller 150 repeats steps S131 and S132 with respect to all the processor modules selected in step S111 to construct the execution sequence list in which a module to be executed subsequently to each processor module is set.

FIG. 7(B) is a diagram showing an example of the execution sequence list obtained by repeating steps S131 and S132 after the execution sequence list shown in FIG. 7(A) is constructed in step S121.

In the execution sequence list shown in FIG. 7(B), as a result of the repetition of steps S131 and S132, the data format conversion module “K” for converting the data format from “x” to “a” is placed before the processor module “A”, the data format conversion module “L” for converting the data format from “a” to “b” is placed before the processor module “C”, and the data format conversion module “M” for converting the data format from “b” to “x” is placed before the processor module “D”.

The module controller 150 provides each module followed by a subsequent module with execution instruction information for instructing the subsequent module to perform processing according to the execution sequence list obtained by repeating steps S131 and S132. In other words, the module controller 150 provides respective modules but one executed last with an interface for instructing the subsequent module to perform processing on completion of its own processing.

The module controller 150 then calls the first module according to the execution sequence list (step S133). More specifically, the module controller 150 instructs the module at the top of the execution sequence list to perform processing.

Having completed part or all of its own processing, each module call the subsequent module sequentially based on the execution instruction information. That is, after the module controller 150 instructs the first module to perform processing, respective modules proceed processing sequentially in the order listed on the execution sequence list.

Incidentally, if, during a series of processing by the respective modules, the processing cannot be continued as when signature verification fails or if it becomes unnecessary to continue the processing, each module may, for example, return control to the module controller 150 without calling the subsequent module to terminate the processing.

The document data which has undergone the processing by the respective modules is stored in the document storage 130. After that, the input/output section 110 outputs the document data as the processing result stored in the document storage 130 (step S116).

As is described above, according to the fifth embodiment, processing is sequentially performed by modules including data format conversion modules according to the execution sequence list. Therefore, it is not necessary to return control to the module controller 150 on completion of processing by each module.

Consequently, the module controller 150 is not required to be in control of the processing of all the modules after calling the first module. Thus, the module controller 150 can process another document data in the meantime, which improves process efficiency.

Besides, each processor module can pass part of document data to the subsequent module even before completing the processing of the entire document data. For example, in the case of document data of ten lines, the processor module can pass the data of three lines to the subsequent module on completion of the processing of the three lines, and thereafter, pass the data of remaining seven lines when having completed the processing of the seven lines. In this manner, a plurality of processor modules can be executed at the same time. Thereby, it becomes possible to improve execution efficiency.

Hereinafter, the sixth embodiment of the present invention will be described.

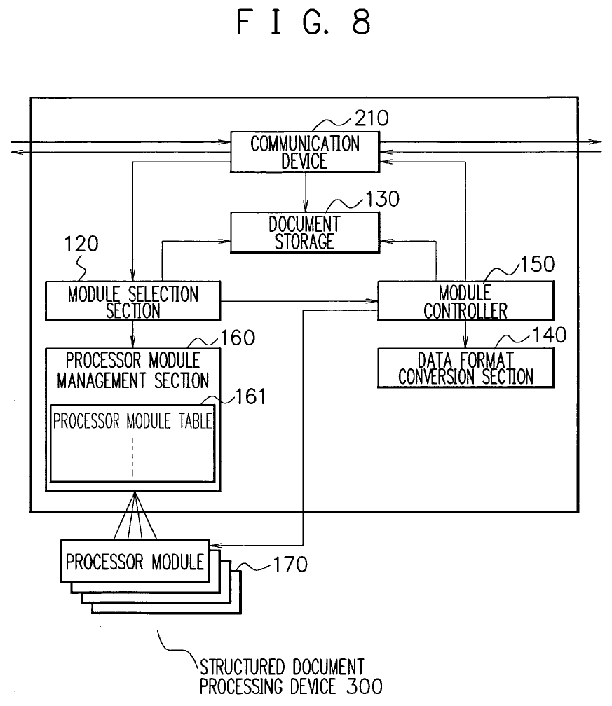

FIG. 8 is a block diagram showing an example of the construction of a structured document processing device according to the sixth embodiment of the present invention. Incidentally, the structured document processing device shown in FIG. 8 is in many respects basically similar to the structured document processing system 100 of FIG. 2, and like numerals are utilized in designating corresponding portions of the system.

As can be seen in FIG. 8, the structured document processing device 300 comprises a communication device 210, a module selection section 120, a document storage 130, a data format conversion section 140, a module controller 150, and a processor module management section 160.

As a substitute for the input/output section 110 of the structured document processing system 100, the structured document processing device 300 is provided with the communication device 210 as an input/output device for dealing with request document data and response document data.

In the following, a description will be given of the operation of the structured document processing device 300 according to the sixth embodiment of the present invention.

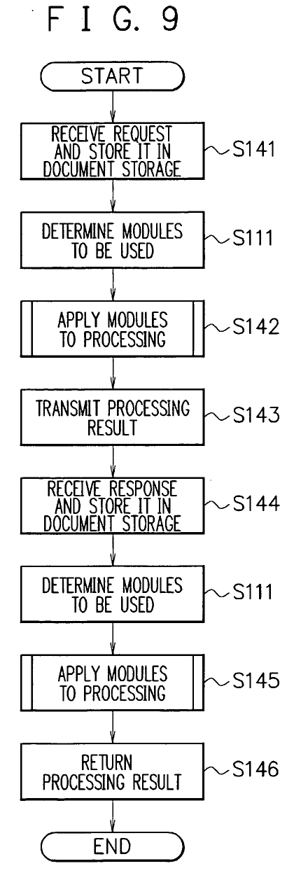

FIG. 9 is a flowchart showing an example of structured document data processing performed by the structured document processing device 300 of the sixth embodiment.

In the structured document data processing, when request document data (request) is input, first, the communication device 210 stores the input data to be processed in the document storage 130 (step S141).

After the request document data is stored in the document storage 130, as in the case of FIG. 3, the module selection section 120 selects processor modules for use in processing the data stored in the document storage 130, and outputs the result of the determination to the module controller 150 (step S111). Incidentally, in this embodiment, the result of the determination as to the processor modules to be used for processing the request document data is temporarily stored so as to be used for the processing of response document data.

Next, the respective processor modules selected for use are applied to processing or made to perform processing (step S142). More specifically, in step S142, the process from step S112 through S115 shown in FIG. 3 is performed.

On completion of the processing of all the processor modules, the communication device 210 outputs request document data representing the processing result stored in the document storage 130 to the receiver of the data (step S143). For example, the receiver of request document data may be set in the data, or registered in the structured document processing device 300 in advance correspondingly to the sender of the data.

When response document data (response) to the request document data is input after the transmission of the request document data, the communication device 210 stores the input data to be processed in the document storage 130 (step S144).

After the response document data is stored in the document storage 130, the module selection section 120 selects processor modules for use in processing the data stored in the document storage 130, and outputs the result of the determination to the module controller 150 (step S111). Incidentally, in step S111, the module selection section 120 selects the processor modules used for processing the request document data to process the response document data based on the information as to the processor modules used for processing the request document data previously stored.

Next, the respective processor modules selected for use are applied to processing or made to perform processing (step S145). More specifically, in step S145, the process from step S112 through S115 shown in FIG. 3 is performed.

On completion of the processing of all the processor modules, the communication device 210 outputs response document data representing the processing result stored in the document storage 130 to the sender of the corresponding request document data (step S146).

As is described above, according to the sixth embodiment, the operation previously described for the first embodiment is performed twice, on receipt of request document data and on receipt of response document data. Information as to processor modules used for processing request document data is retained, and according to which, processor modules used for processing response document data are determined.

To be more precise, encryption and decryption processor modules used for processing request document data may be retained to use them for processing response document data corresponding to the request document data. Thereby, the same processor module can perform encryption and decryption for request document data and response document data in association with each other.

That is, according to the sixth embodiment, processor modules used for processing request document data are retained. The module selection section 120 selects the processor modules used for processing request document data to use them for processing response document data corresponding to the request document data. Thus, information obtained in the processing of request document data can be used on receipt of corresponding response document data. Further, it is possible to determine appropriate processor modules used for processing response document data with a simple structure.

Hereinafter, the seventh embodiment of the present invention will be described.

A structured document processing device of the seventh embodiment has essentially the same construction as described previously for the structured document processing device 300 in connection with FIG. 8. Therefore, the construction of the structured document processing device of the seventh embodiment will be described referring to FIG. 8, and the detailed description will not be repeated here.

In the following, a description will be given of the operation of the structured document processing device 300 according to the seventh embodiment of the present invention.

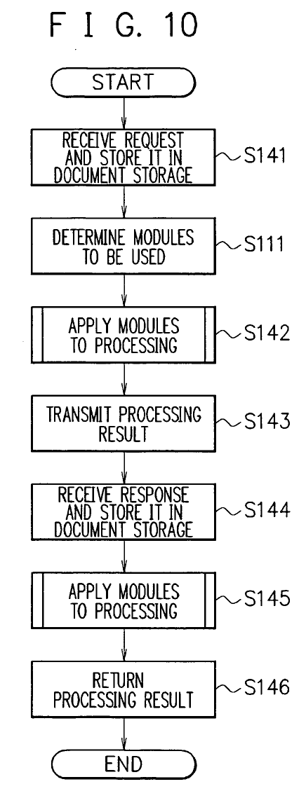

FIG. 10 is a flowchart showing an example of structured document data processing performed by the structured document processing device 300 of the seventh embodiment.

In the structured document data processing, when request document data (request) is input, first, the communication device 210 stores the input data to be processed in the document storage 130 (step S141).

After the request document data is stored in the document storage 130, as in the case of FIG. 3, the module selection section 120 selects processor modules for use in processing the data stored in the document storage 130, and outputs the result of the determination to the module controller 150 (step S111). Incidentally, in this embodiment, the result of the determination as to the processor modules to be used for processing the request document data is stored in a storage medium so as to be used for the processing of response document data.

Next, the respective processor modules selected for use are applied to processing or made to perform processing (step S142). More specifically, in step S142, the process from step S112 through S115 shown in FIG. 3 is performed.

On completion of the processing of all the processor modules, the communication device 210 outputs request document data representing the processing result stored in the document storage 130 to the receiver of the data (step S143). For example, the receiver of request document data may be set in the data, or previously registered in the structured document processing device 300 in association with the sender of the data.

When response document data (response) to the request document data is input after the transmission of the request document data, the communication device 210 stores the input data to be processed in the document storage 130 (step S144).

Next, the respective processor modules selected for use are applied to processing or made to perform processing (step S145). More specifically, in step S145, the process from step S112 through S115 shown in FIG. 3 is performed. Incidentally, in step S145, the processor modules used for processing the request document data are applied to the processing of the response document data.

On completion of the processing of all the processor modules, the communication device 210 outputs response document data representing the processing result stored in the document storage 130 to the sender of the corresponding request document data (step S146).

As is described above, according to the seventh embodiment, step S111 before step S145 in FIG. 9 to select processor modules for use in processing response document data is skipped. Information as to processor modules used for processing request document data is stored in a storage medium so that the same modules can be used for the processing of response document data.

Incidentally, a called processor module may be provided with information on which document data (request document data or response document data) is to be processed by the module controller 150. With this construction, the called processor module can recognize if it is to be stored or not.

That is, according to the seventh embodiment, processor modules used for processing request document data are used to process response document data. Thus, information obtained in the processing of request document data can be used on receipt of corresponding response document data. Moreover, the step in which the module selection section 120 selects processor modules for use in processing response document data can be omitted. In addition, it is possible to process response document data by appropriate processor modules with a simple structure.

Further, according to the seventh embodiment, since the step to select processor modules for use in processing response document data is skipped, execution efficiency can be improved.

Besides, if processor modules are provided with information as to whether the module controller 150 is to process request document data or response document data, the respective modules can perform appropriate processing.

Although not particularly mentioned in the above embodiments, the processor modules and the conversion modules may be installed in an external device outside the structured document processing systems 100 and 200, or the structured document processing device 300. In this case, the module controller 150 may instruct the processor modules and the conversion modules to perform processing via a communication network such as the Internet, a public line, a private line and a radio communication line.

Incidentally, a variety of the control operations in the structured document processing systems 100 and 200, or the structured document processing device 300 of the respective embodiments are implemented by a structured document processing program 520 for the structured document data processing.

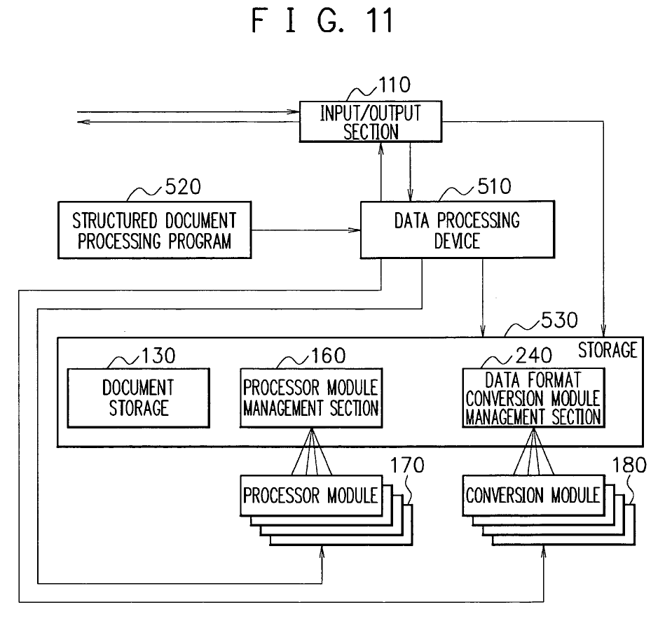

FIG. 11 is a block diagram showing a construction including the structured document processing program 520 for the structured document data processing and a data processing device 510 which operates under the control of the structured document processing program 520. Referring to FIG. 11, the construction further comprises an input/output section 110, and a storage 530 including a document storage 130, a processor module management section 160 and a data format conversion module management section 240.

The data processing device 510 is a controller that corresponds to the whole part for performing the various control operations in the structured document processing systems 100 and 200, or the structured document processing device 300 of the first to seventh embodiments.

The structured document processing program 520 is a control program for making the data processing device 510 perform the aforementioned various operations, and may be installed in the device 510.

The data processing device 510 writes/reads data to/from the storage 530 under the control of the structured document processing program 520 as well as implementing the various control operations previously described for the first to seventh embodiments.

Although not particularly mentioned in the above embodiments, instead of document data itself, an reference (address) pointer or an address at which the document data is stored in the document storage 130 may be provided to the processor modules, the data format conversion section 140 and the data format conversion modules so that they can directly access and process the data on the document storage 130.

Further, existing remote module call techniques such as RPC (Remote Procedure Call), RMI (Remote Method Invocation) and ICAP (Internet Content Adaptation Protocol) may be utilized for the processor modules and the data format conversion modules.

Still further, in the embodiments described above, the input/output section 110 and the communication device 210 may process inputs/outputs to/from a communication network.

Still further, document data may be structured document data such as XML document data.

A description will now be made of the first example of carrying out the invention in practice.

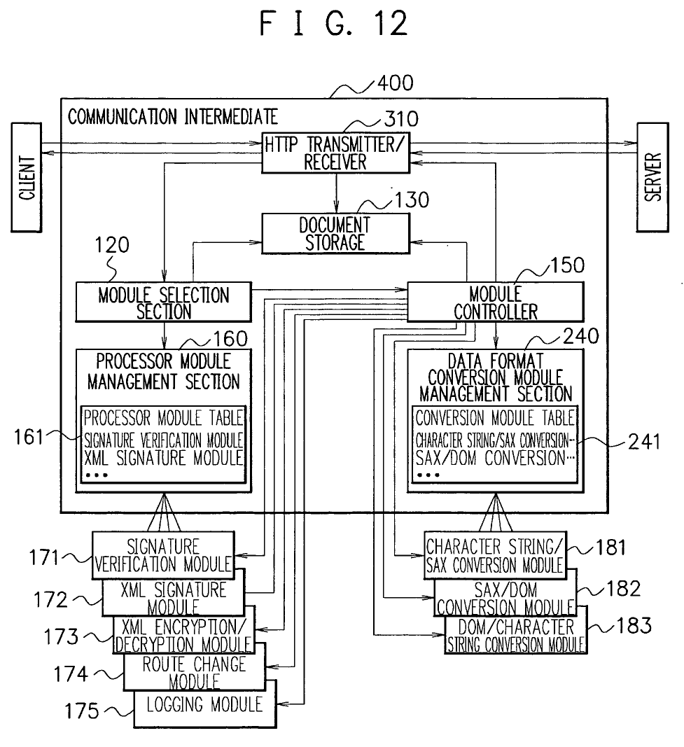

FIG. 12 is a block diagram showing the construction of a structured document processing device according to the first practical example of the present invention.

In the first practical example, the structured document processing device is applied to a communication repeater which relays data communication to exchange XML documents using HTTP (HyperText Transfer Protocol).

As can be seen in FIG. 12, the communication repeater 400 comprises a module selection section 120, a document storage 130, a module controller 150, a processor module management section 160, a data format conversion module management section 240, and an HTTP transmitter/receiver 310.

The HTTP transmitter/receiver 310 has HTTP client/server functions as a communication device. More specifically, the HTTP transmitter/receiver 310 serves as an HTTP server for receiving request document data and returning response document data, and also as an HTTP client for issuing request document data to a server and receiving response document data. Incidentally, the HTTP transmitter/receiver 310 uses a character string format as an input/output format.

In this example, the module selection section 120 selects processor modules for use based on the address of a client and a destination URL (Uniform Resource Locater).

As processor modules, a signature verification module 171, an XML signature module 172, an XML encryption/decryption module 173, a route change module 174 and a logging module 175 are registered in a processor module table 161 of the processor module management section 160. The logging module 175 processes document data in SAX format as an input/output format. Similarly, the signature verification module 171 processes document data in SAX format. The XML signature module 172 and the XML encryption/decryption module 173 process document data in DOM format. The route change module 174 process document data in character string format.

Incidentally, in this example, it is predetermined as a sequence constraint that the XML signature module 172 must be executed before the XML encryption/decryption module 173.

Besides, as data format conversion modules, a character string/SAX conversion module 181, a SAX/DOM conversion module 182 and a DOM/character string conversion module 183 are registered in a conversion module table 241 of the data format conversion module management section 240. The character string/SAX conversion module 181 performs a conversion between character string and SAX formats. The SAX/DOM conversion module 182 performs a conversion between SAX and DOM formats. The DOM/character string conversion module 183 performs a conversion between DOM and character string formats.

DOM is a format that treats an XML document as a tree-structured object or a tree of nodes, while SAX treats an XML document as a series of events such as a start tag and an end tag.

The DOM format was standardized by a standards organization called W3C (World Wide Web consortium), and the specification is described on the Internet at http://w3.org/TR/DOM-Level-2-Core/.

On the other hand, the SAX format was developed as a standard interface for event-based XML analysis, and the packaging manual is located on the Internet at http://java.sun.com/j2se/1.4/ja/docs/ja/api/org/xml/sax/package-summary.html.

In the following, a description will be given of the operation of the communication repeater 400 in this example for performing structured document data processing. The structured document data processing described hereinbelow corresponds to that shown in FIG. 10.

In the structured document data processing, having received a request XML document (request document data) from a client, the HTTP transmitter/receiver 310 stores the data in the document storage 130 on a memory with information on a request source, an HTTP header and the like (refer to step S141).

Subsequently, the module selection section 120 selects processor modules to be used (refer to step S111). For example, it is assumed that the module selection section 120 has determined to use the XML signature module 172, the XML encryption/decryption module 173, and the route change module 174.

The module controller 150 checks that document data stored in the document storage 130 is in character string format, and a data format necessary for output is character string format. The module controller 150 also checks data formats required by the respective processor modules 172, 173 and 174, and constraints on the execution sequence or order of the processor modules. Accordingly, the module controller 150 determines to execute the XML signature module 172, the XML encryption/decryption module 173, and the route change module 174 in the order named so that the number of data format conversions can be minimized as the sequence constraints are satisfied (refer to step S121).

Incidentally, the execution sequence may be determined to minimize the whole processing time instead of minimizing the number of data format conversions. For example, a data conversion from character string to DOM format takes longer time than a data conversion from character string to SAX format. As just described, the time taken to perform a data conversion differs for different types of data formats. Therefore, the expected processing time may be calculated with respect to all possible execution sequences to select the one with the shortest processing time.

After the module controller 150 has determined the execution sequence, because the document data stored in the document storage 130 is in character string format while the data format required by the XML signature module 172 is DOM, the data stored in the document storage 130 is converted into DOM format. The conversion is made by the DOM/character string conversion module 183 registered in the conversion module table 241 of the data format conversion module management section 240 (refer to steps S112 and S113).

Next, the module controller 150 instructs the XML signature module 172 to perform processing (refer to step S114). Then, the module controller 150 instructs the next XML encryption/decryption module 173 to perform processing (refer to steps S115/Yes, S112/No, and S114). Since the document data stored in the document storage 130 has already been converted to DOM, no data format conversion is carried out before processing by the XML encryption/decryption module 173.

Further, the module controller 150 instructs the route change module 174 to perform processing (refer to steps S115/Yes, S112, S113, and S114) after the DOM/character string conversion module 183 has converted the document data stored in the document storage 130 to character string format required by the module 174.

Incidentally, although the HTTP transmitter/receiver 310 requires the character string format, no data format conversion is necessary because the document data stored in the document storage 130 has already been converted to character string format.

The HTTP transmitter/receiver 310 transmits the request message created by the above processing to a destination server (refer to step S143). The HTTP transmitter/receiver 310 receives a response from the server, and stores it in the document storage 130 (refer to step S144).

The module selection section 120 selects the XML encryption/decryption module 173 for use in processing the response based on the information about the client and destination URL obtained on receipt of the request (refer to step S111).

Thereafter, since the document data stored in the document storage 130 is in character string format, the data stored in the document storage 130 is converted to DOM by the DOM/character string conversion module 183 (refer to steps S112 and S113). Then, the XML encryption/decryption module 173 performs decryption (refer to step S114).

After the DOM/character string conversion module 183 has converted the document data to character string format, the HTTP transmitter/receiver 310 returns a response message to the client (refer to step S146).

A description will now be made of the second example of carrying out the invention in practice.

In the second practical example, the structured document processing device is applied to the communication repeater 400 shown in FIG. 12 as in the first practical example.

In the following, a description will be given of the operation of the communication repeater 400 in this example for performing structured document data processing. The structured document data processing described hereinbelow corresponds to that shown in FIG. 6.

For example, it is assumed that the module selection section 120 has determined to use the signature verification module 171 and the logging module 175 which require the SAX format (refer to step S111).

Since the HTTP transmitter/receiver 310 uses a character string format as an input/output format and the data format required by the modules for use is SAX, the module controller 150 determines to execute the character string/SAX conversion module 181, the signature verification module 171, the logging module 175 and the character string/SAX conversion module 181 in the order named. Then, the module controller 150 constructs an execution sequence list. On the execution sequence list, the processor modules are set in the order in which the modules will perform processing (refer to steps S121, S131, S132 and S115).

Next, the module controller 150 instructs the character string/SAX conversion module 181, the first module in the execution sequence, to convert document data in character string format into SAX format (refer to step S133).

Having converted the XML document data in character string format into SAX format, the character string/SAX conversion module 181 passes the data in SAX format to the signature verification module 171 set as the next processor module.

On completion of its own processing, the signature verification module 171 passes the XML document data, which is still in SAX format, to the next logging module 175. The logging module 175 writes necessary information to a log, and passes the XML document data, which is still in SAX format, to the next character string/SAX conversion module 181.

The character string/SAX conversion module 181 temporarily retains the XML document data in SAX format to convert it to character string format.

The above process is repeated until the processing of the entire XML document data in SAX format has been completed.

After that, the character string/SAX conversion module 181 converts the entire XML document data in SAX format to character string format, and stores the XML document data in character string format in the document storage 130.

The HTTP transmitter/receiver 310 transmits the XML document data in character string format to the destination server (refer to step S116).

A description will now be made of the third example of carrying out the invention in practice.

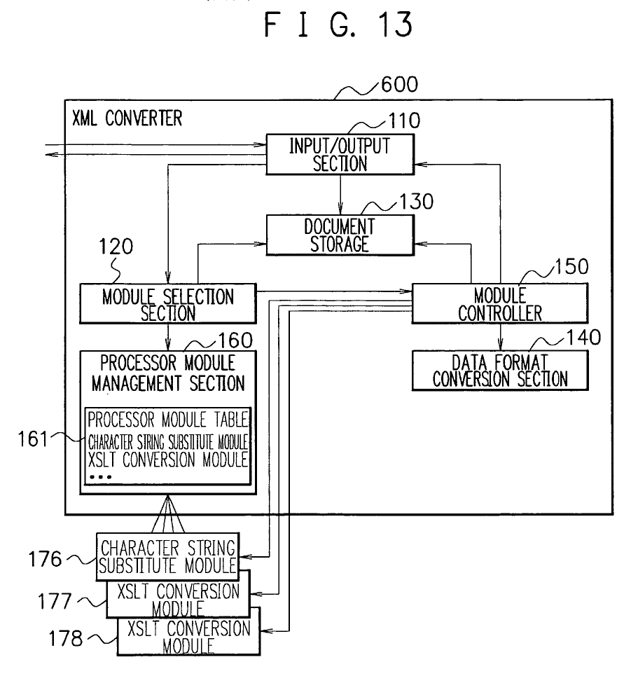

FIG. 13 is a block diagram showing the construction of a structured document processing device according to the third practical example of the present invention.

In the third practical example, the structured document processing device is applied to an XML converter which is provided with an input/output device to a file as an input/output section 110 and carries out a character string substitute and an XSLT conversion for XML data written to a file.

As can be seen in FIG. 13, the XML converter 600 comprises an input/output section 110, a module selection section 120, a document storage 130, a data format conversion section 140, a module controller 150, and a processor module management section 160.

As processor modules, a character string substitute module 176, and XSLT conversion modules 177 and 178 are registered in a processor module table 161 of the processor module management section 160. The character string substitute module 176 receives a character string, while the XSLT conversion modules 177 and 178 receive document data in DOM format.

When the user of the XML converter 600 operates an input device such as a keyboard (not shown) to input the location of a file in the converter 600, the input/output section 110 reads the file into the document storage 130.

Based on the location of the file, the module selection section 120 determines whether to perform only a character string substitute by the character string substitute module 176 or to perform an XSLT conversion by either or both the XSLT conversion modules 177 and 178 in addition to the character string substitute.

When no XSLT conversion is to be made, the module controller 150 passes the character string read in the document storage 130 to the character string substitute module 176, and outputs the result through the input/output section 110.

On the other hand, when an XSLT conversion is to be made, the module controller 150 instructs the data format conversion section 140 to convert the data format to DOM, and calls either or both the XSLT conversion modules 177 and 178. After processing, the module controller 150 instructs the data format conversion section 140 to restore the result of the processing to character string format, and outputs it to the file through the input/output section 110.

As set forth hereinabove, in accordance with the present invention, when the data format of structured document data to be processed by a processor module differs from that required by the processor module, the structured document data is converted to a data format acceptable to the processor module. Consequently, in a system where processor modules are dynamically selected for use in processing structured document data, when the respective modules require different data formats, syntax analysis and data format conversion can be minimized. Thus, it is possible to improve process efficiency.

Further, the present invention can be applied to a communication repeater which processes structured document data to convert a message, and is also applicable to a structured document converter which dynamically changes processing using a plurality of plug-ins or software programs.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A structured document processing device processing structured document data used in a plurality of data formats with one or more processor modules, which selects one or more processor modules for use in processing received structured document data from among a plurality of processor modules each processing data in a specified format, and, when instructing the processor module selected for use to perform processing, determines whether or not the data format acceptable to the processor module matches that of the structured document data to be processed by the processor module to convert the structured document data to the data format acceptable to the processor module if the data formats have been determined to be mismatched, thereby processing the structured document data by the processor module and outputting the processing result.

2. A structured document processing device processing structured document data used in a plurality of data formats with one or more processor modules, comprising:
a receiver for receiving structured document data;
a processor module selector for selecting one or more processor modules for use in processing the structured document data received by the receiver from among a plurality of processor modules each processing data in a specified format;
a module controller for instructing the processor module selected for use by the processor module selector to perform processing;
a data format converter for converting the data format of the structured document data; and
a transmitter for transmitting the processing result obtained by the processor module selected by the processor module selector; wherein:
the module controller includes a determination means for, when the module controller instructs the processor module selected for use to perform processing, determining whether or not the data format acceptable to the processor module matches that of the structured document data to be processed by the processor module; and
the data format converter converts the structured document data to the data format acceptable to the processor module if the determination means has determined that the data formats do not match.

3. The structured document processing device claimed in claim 2, further comprising a document data storage for storing structured document data received by the receiver, wherein:
the module controller stores the processing result obtained by the processor module selected for use by the processor module selector in the document data storage; and
the transmitter transmits the processing result stored in the document data storage.

4. The structured document processing device claimed in claim 2, wherein the data format converter is composed of one or more data format conversion modules for converting the data format of structured document data.

5. The structured document processing device claimed in claim 4, wherein the module controller also instructs the data format conversion module to perform processing, determines the execution sequence of the processor modules selected by the processor module selector and the data format conversion modules necessary for the data format conversion, provides each module with information on instructions for the execution of a module subsequent to the module, and instructs the first module to perform processing.

6. The structured document processing device claimed in claim 5, wherein the module controller selects one execution sequence of the processor modules and the data format conversion modules from a number of possible execution sequences so that the entire load of processing performed by the processor modules and the data format conversion modules is minimized.

7. The structured document processing device claimed in claim 5, wherein the module controller determines the execution sequence of the processor modules and the data format conversion modules within predetermined constraints on the execution sequence of the processor modules.

8. The structured document processing device claimed in claim 2, wherein:
the processor modules are installed in an external device outside the structured document processing device; and
the module controller instructs the processor module installed in the external device to perform processing via a communication network.

9. The structured document processing device claimed in claim 5, wherein:
the data format conversion modules include one or more of those installed in an external device outside the structured document processing device; and
the module controller instructs the data format conversion module installed in the external device to perform processing via a communication network.

10. The structured document processing device claimed in claim 2, wherein:
the receiver receives structured document data via a communication network; and
the transmitter transmits the processing result obtained by the processor module via a communication network.

11. The structured document processing device claimed in claim 2, wherein:
the receiver receives request document data as structured document data, and response document data returned in response to the result of processing the request document data obtained by the processor module; and
the transmitter transmits the result of processing the request document data obtained by the processor module, and the result of processing the response document data obtained by the processor module.

12. The structured document processing device claimed in claim 11, wherein the processor module selector determines to use one or more processor modules used for processing the request document data for processing the response document data.

13. The structured document processing device claimed in claim 11, wherein the module controller retains one or more processor modules used for processing the request document data, and uses the processor modules for processing the response document data so that the processor module selector need not select one or more processor modules to be used for processing the response document data.

14. The structured document processing device claimed in claim 2, wherein the structured document data is XML document data.

15. A structured document processing method for processing structured document data used in a plurality of data formats with one or more processor modules, comprising the steps of:
receiving structured document data;
selecting one or more processor modules for use in processing the received structured document data from among a plurality of processor modules each processing data in a specified format;
instructing the processor module selected for use to perform processing;
determining, when instructing the processor module selected for use to perform processing, whether or not the data format acceptable to the processor module matches that of the structured document data to be processed by the processor module; and
converting the structured document data to the data format acceptable to the processor module if the data formats have been determined to be mismatched.

16. The structured document processing method claimed in claim 15, wherein the conversion of data format is implemented by one or more data format conversion modules for converting the data format of structured document data.

17. The structured document processing method claimed in claim 16, further comprising the steps of:
determining the execution sequence of the processor modules selected for use and the data format conversion modules necessary for the data format conversion;
providing each module with information on instructions for the execution of a module subsequent to the module; and
instructing the first module to perform processing.

18. The structured document processing method claimed in claim 17, wherein one execution sequence of the processor modules and the data format conversion modules is selected from a number of possible execution sequences so that the entire load of processing performed by the processor modules and the data format conversion modules is minimized.

19. The structured document processing method claimed in claim 17, wherein the execution sequence of the processor modules and the data format conversion modules is determined within predetermined constraints on the execution sequence of the processor modules.

20. A structured document processing program for processing structured document data used in a plurality of data formats with one or more processor modules, making a computer perform the steps of:
receiving structured document data;
selecting one or more processor modules for use in processing the received structured document data from among a plurality of processor modules each processing data in a specified format;
instructing the processor module selected for use to perform processing;
determining, when instructing the processor module selected for use to perform processing, whether or not the data format acceptable to the processor module matches that of the structured document data to be processed by the processor module; and
converting the structured document data to the data format acceptable to the processor module if the data formats have been determined to be mismatched.

21. The structured document processing program claimed in claim 20, wherein the conversion of data format is implemented by one or more data format conversion modules for converting the data format of structured document data.

22. The structured document processing program claimed in claim 21, making a computer perform the further steps of:
determining the execution sequence of the processor modules selected for use and the data format conversion modules necessary for the data format conversion;
providing each module with information on instructions for the execution of a module subsequent to the module; and
instructing the first module to perform processing.

23. The structured document processing program claimed in claim 22, wherein one execution sequence of the processor modules and the data format conversion modules is selected from a number of possible execution sequences so that the entire load of processing performed by the processor modules and the data format conversion modules is minimized.

24. The structured document processing program claimed in claim 22, wherein the execution sequence of the processor modules and the data format conversion modules is determined within predetermined constraints on the execution sequence of the processor modules.
